(19) United States
(12) Patent Application Publication
(10) Pub. No.: US 2020/0145246 A1
(43) Pub. Date: May 7, 2020

(54) INFORMATION PROCESSING APPARATUS AND INFORMATION PROCESSING METHOD

(71) Applicant: SHARP KABUSHIKI KAISHA, Sakai City (JP)

(72) Inventors: KAZUYOSHI HADA, Sakai City (JP); TAKASHI OHTA, Sakai City (JP)

(21) Appl. No.: 16/670,205

(22) Filed: Oct. 31, 2019

(30) Foreign Application Priority Data
Nov. 7, 2018 (JP) 2018-209856

(51) Int. Cl. H04L 12/28; H04L 29/08

(52) U.S. Cl. CPC H04L 12/2825; H04L 12/282; H04L 2012/2841; H04L 67/22; H04L 2012/285; H04L 67/12

(57) ABSTRACT

In a watching server including a communication unit and a control unit, the control unit acquires log information indicating a use status of a home appliance by a watching target person and schedule information indicating a schedule of the watching target person, via the communication unit, and determines notification information to be notified to the watching target person with reference to the log information and the schedule information.

### BACKGROUND

### 1. Field

The present disclosure relates to an information processing apparatus and an information processing method.

### 2. Description of the Related Art

In a watching system of a related art, a watching target person makes going-out setting on a television screen, or a watching manager sets a watching schedule of the watching target person on a watching list screen. Thereby, in a time zone when the going-out setting of the watching target person is made, it is determined that the television is in a normal state even though the television is turned off for a time longer than a threshold, and thereby, no warning is given to the watching manager.

Japanese Unexamined Patent Application Publication No. 2014-021851 (published on Feb. 3, 2014) discloses a technology in which going-out setting is made by operating a television and if the television is turned off, a going-out state is turned on at that time. Further, Japanese Unexamined Patent Application Publication No. 2017-054206 (published on Mar. 16, 2017) discloses a technology in which a watching manager inputs a going-out schedule of a watching target person on a watching list screen.

However, if the television is turned on for a time longer than or equal to the threshold during the time zone when the going-out setting of the watching target person is made, it is determined that the television is in an abnormal state, and thus, a warning is given to the watching manager. However, since there is a possibility that the watching target person forgets the going-out schedule, it is considered that priority has to be given to confirm the watching target person rather than warning the watching manager.

It is desirable to realize an appropriate going-out confirmation.

### SUMMARY

According to one aspect of the disclosure, there is provided an information processing apparatus including a communication unit and a control unit, in which the control unit acquires log information indicating a use status of a home appliance by a target person and schedule information indicating a schedule of the target person, via the communication unit, and determines notification information to be notified to the target person with reference to the log information and the schedule information.

According to another aspect of the disclosure, an information processing method using an information processing apparatus includes acquiring log information indicating a use status of a home appliance by a target person and schedule information indicating a schedule of the target person, and determining notification information to be notified to the target person with reference to the log information and the schedule information.

### Advantageous Effects of Invention

An aspect of the disclosure advantageously realizes an appropriate going-out confirmation.

### BRIEF DESCRIPTION OF THE DRAWINGS

FIG. 1 is a diagram illustrating a configuration of an at-home determination system according to a first embodiment of the present disclosure;

FIG. 2 is a block diagram illustrating a configuration of a watching server according to the first embodiment of the present disclosure;

FIG. 3 is a sequence diagram illustrating processing of the at-home determination system according to the first embodiment of the present disclosure;

FIG. 4 is a diagram illustrating an example of the processing of the at determination system according to the first embodiment of the present disclosure; and

FIG. 5 is a block diagram illustrating a configuration of a computer that can be used as the watching server according to a fifth embodiment of the present disclosure.

### DESCRIPTION OF THE EMBODIMENTS

### First Embodiment

Hereinafter, a first embodiment of the present disclosure will be described in detail.

### At-home Determination System 1

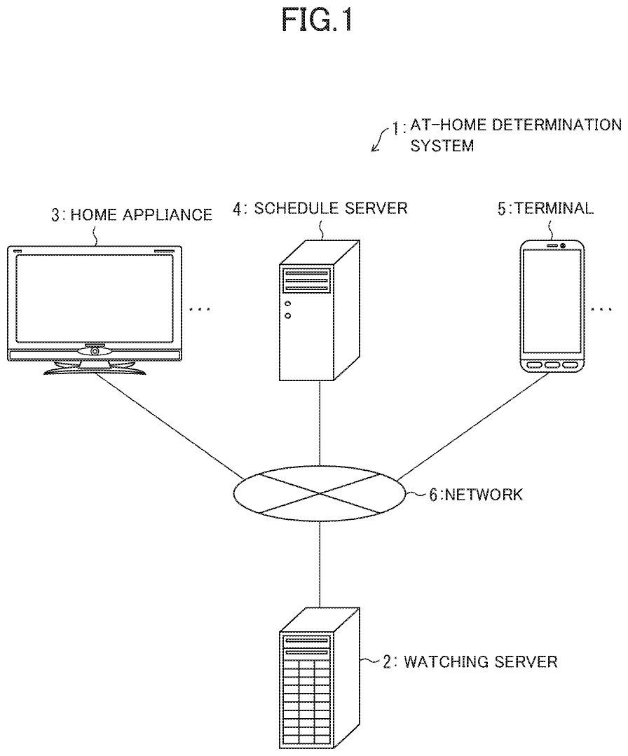

FIG. 1 is a diagram illustrating a configuration of an at-home determination system 1 according to the present embodiment. In the at-home determination system 1, a schedule management of a watching target person (target person) is linked to a calendar application, and if the watching target person inputs a schedule to the calendar application, the schedule is reflected in the schedule management. When a calendar schedule is a going-out schedule but a home appliance such as TV is operating, the at-home determination system 1 notifies the watching target person to confirm the going-out schedule.

Here, a “watch target person” means a person who demands to watch, such as an elderly person living alone. The “watching person” means a watching manager who manages the watching target person, such as a relative of the watching target person, a staff member of a local government or a civil welfare committeeman.

The at-home determination system 1 determines whether or not the watching target person is at home by a log of a home appliance, collate a determination result with an going-out schedule of a schedule input by the watching target person, and confirms the going-out schedule to the watching target person according to the collation result. As illustrated in FIG. 1, the at-home determination system 1 is configured such that a watching server (information processing apparatus) 2, a home appliance 3, a schedule server 4, and a terminal 5 are connected to each other via a network 6 so as to communicate with each other.

The watching server 2 acquires log information indicating a use status of the home appliance 3 by a person watched from the home appliance 3, acquires schedule information indicating a schedule of the watching target person from the schedule server 4, and transmits notification information to the terminal 5 of a person watching over toe watching target person with reference to the log information and the schedule information.

The home appliance 3 is used by the watching target person, and is, for example, a television, a radio, a lighting device, or the like. As for the home appliance 3, at least one home appliance is applied to the at-home determination system 1 for each watching target person. Here, is desirable that a power-on state of the home appliance 3 indicates that a user is at home.

The schedule server 4 is a device that manages calendar data 41 including a calendar and a going-out schedule of the watching target person. The schedule server 4 works in conjunction with a terminal (for example, a PC, a smartphone, a tablet terminal, or the like) in which a calendar application is installed, and if the watching target person inputs an event to the calendar application of the terminal, the calendar data 41 reflects the event of the watching target person and whether or not the event is a going-out schedule. In this case, the schedule server 4 determines whether or not the input event is a going-out schedule, and when the event is the going-out schedule, the schedule server 4 sets a flag indicating that the event is the going-out schedule in association with the event.

The terminal 5 is carried by the watching target person, and is, for example, a smartphone, a tablet terminal or the like. As for the terminal 5, at least one terminal is applied to the at-home determination system 1 for each watching target person. The network 6 is a communication network such as the Internet.

### Watch server 2

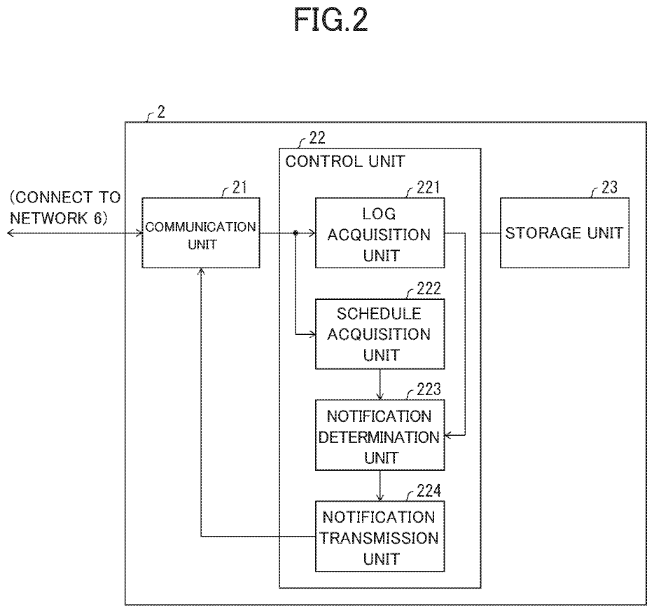

FIG. 2 is a block diagram illustrating a configuration of the watching server 2 according to the present embodiment. As illustrated in FIG. 2, the watching server 2 includes a communication unit 21, a control unit 22, and a storage unit 23. The watching server 2 may include a plurality of the communication units 21 and a plurality of the control units 22.

The communication unit 21 is connected to the network 6 and communicates with the home appliance 3, the schedule server 4, and the terminal 5 via the network 6.

As illustrated in FIG. 2, the control unit 22 functions as a log acquisition unit 221, a schedule acquisition unit 222, a notification determination unit 223, and a notification transmission unit 224. The log acquisition unit 221 acquires log information indicating a use status of the home appliance 3 by the watching target person from the home appliance 3 via the communication unit 21. The schedule acquisition unit 222 acquires schedule information indicating a schedule of the watching target person from the schedule server 4 via the communication unit 21.

The notification determination unit 223 determines notification information to be notified to the watching target person with reference to the log information acquired by the log acquisition unit 221 and the schedule information acquired by the schedule acquisition unit 222. The notification transmission unit 224 transmits the notification information determined by the notification determination unit 223 to the terminal 5 via the communication unit 21.

The storage unit 23 stores and reads data under a control of the control unit 22. The storage unit 23 stores in advance a database in which device identification information of the home appliance 3, personal identification information of the watching target person, and terminal identification information of the terminal 5 are associated with each other by a table or the like. The storage unit 23 is configured by, for example, a hard disk drive (HDD), a solid state drive (SSD), or the like.

### Processing of At-home Determination System 1

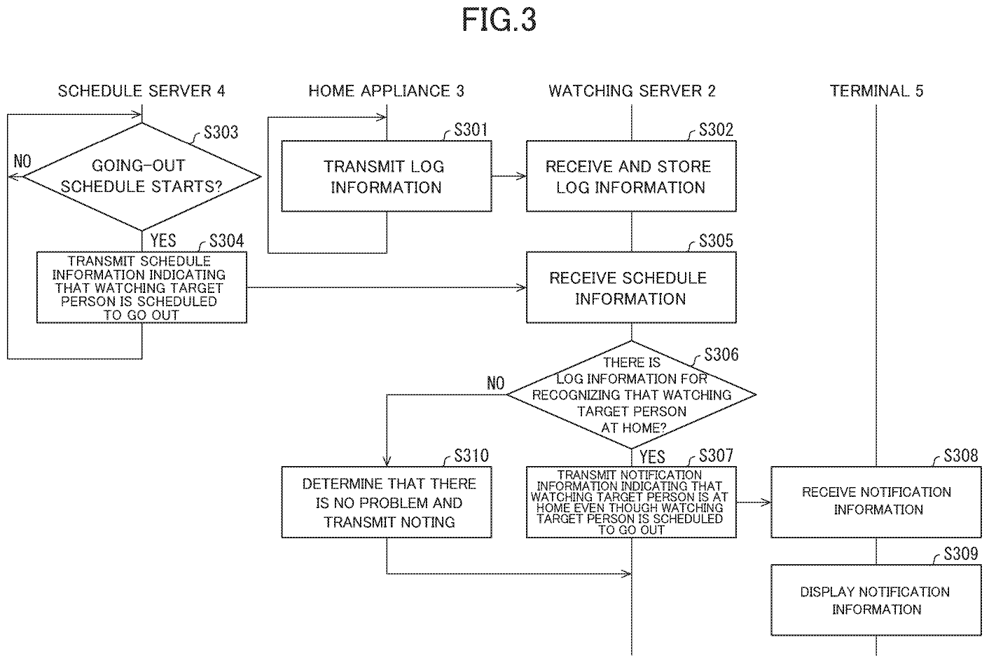

FIG. 3 is a sequence diagram illustrating processing (information processing method) of the at-home determination system 1 according to the present embodiment.

### Step S301

The home appliance 3 transmits log information indicating a use status of the home appliance 3 to the watching server 2. The log information includes, for example, device identification information, power-on time, power-off time, a power-on state for a predetermined time (for example, 24 hours or the like) or more, a power-off state for a predetermined time or more, and the like.

### Step S302: Acquisition Step

In the watching server 2, the log acquisition unit 221 of the control unit 22 receives log information from the home appliance 3 via the communication unit 21 and stores the log information in the storage unit 23. The log information includes the device identification information, the power-on time, the power-off time, and the like.

The device identification information is unique information for the home appliance 3 and is associated with personal identification information of the watching target person in the database of the storage unit 23. The power-on time is the time when the home appliance 3 is turned on. The power-off time is the time when the home appliance 3 is turned off. Thus, the control unit 22 specifies that the watching target person is using the home appliance 3 from the power-on time to the power-off time. further, the control unit 22 specifies the time from the power-on time to the power-off time as use time of the home appliance 3.

### Step S303

The schedule server 4 holds the calendar data 41 including a going-out schedule of a calendar application user. The schedule server 4 constantly monitors data in which a going-out flag is set among the calendar data 41 of the watching target person and determines whether or not going-out scheduled time starts soon (for example, 15 minutes before the going-out schedule time). If there is the calendar data 41 indicating that the going-out schedule will start soon (YES in step S303), the schedule server 4 executes processing of step S304. If there is no calendar data 41 indicating that the going-out schedule will start soon (NO in step S303), the schedule server 4 repeats the determination of step S303.

### Step 5304

The schedule server 4 transmits schedule information indicating that the watching target person is scheduled to go out to the watching server 2. In this case, the schedule server 4 transmits the schedule information including a personal identification information of the watching target person to the watching server 2.

The watching server 2 may periodically (for example, every hour on the hour) inquire the schedule server 4 about the latest (for example, within one hour) going-out schedule or may collectively inquire the going-out schedule of the day at around 0:00 every day.

### Step S305: Acquisition Step

In the watching server 2, the schedule acquisition unit 222 of the control unit 22 receives the schedule information from the schedule server 4 via the communication unit 21 and stores the schedule information in the storage unit 23. The schedule information includes the going-out schedule of the watching target person, the personal identification information, and the like. If the current time is included in a going-out schedule time zone, the schedule information indicates that the watching target person is out. Meanwhile, if the current time is not included in the going-out schedule time zone, the schedule information indicates that the watching target person is not out, that is, at home. The watching server 2 may receive the schedule information from a terminal in which the calendar application is installed instead of the schedule server 4.

### Step S306

In the watching server 2, the notification determination unit 223 of the control unit 22 determines whether or not there is log information for recognizing that the watching target person who is scheduled to go out is at home. In detail, the notification determination unit 223 determines whether or not the schedule information received in step S305 indicates that the watching target person is out, and the log information stored in the storage unit 23 in step 5302 indicates that the watching target person is using the home appliance 3. In this case, the notification determination unit 223 specifies the log information including the device identification information associated with the personal identification information included in the schedule information in the database of the storage unit 23, and performs the above determination in relation to the log information.

If there is the log information for recognizing that the watching target person scheduled to go out is at home (YES in step S306), the control unit 22 performs processing of step S307. If there is no log information for recognizing that the watching target person scheduled to go out is at home (NO in step S306), the control unit 22 performs processing of step S310.

### Step S307: Determination Step

In the watching server 2, if the schedule information indicates that the watching target person is out and the log information indicates that the watching target person is using the home appliance 3, the notification determination unit 223 of the control unit 22 generates the notification information for confirming the going-out schedule of the watching target person because the watching target person is at home even though the watching target person is scheduled to go out. For example, there is a possibility that the watching target person forgets to go out.

Then, the notification transmission unit 224 transmits the notification information to the terminal 5 via the communication unit 21. The terminal identification information including an IP address of the terminal 5, a mail address of the watching target person, and the like which are demanded for transmission of the notification information is associated with the personal identification information of the watching target person in the database of the storage unit 23.

### Step S308

The terminal 5 receives the notification information for confirming the going-out schedule from the watching server 2 to the watching target person.

### Step S309

The terminal 5 displays the notification information for confirming the going-out schedule to the watching target person.

The notification information may be changed before and after the event. If the going-out schedule time of the watching target person is approaching, when there is the log information for recognizing that the watching target person is at home, the terminal 5 displays that the time to go out is approaching to the watching target person. Meanwhile, if a predetermined time elapses after the going-out schedule time of the watching target person elapses, and when there is the log information for recognizing that the watching target person is at home, the terminal 5 displays that the watching tar het person is at home at a going-out schedule time zone to the watching target person.

For example, if a television of an elderly person living alone (the watching target person) is on even 10 minutes before a hospital visit schedule, the terminal 5 of the elderly person living alone displays the notification information indicating a confirmation of the hospital visit schedule to the elderly person living alone. The television may display the notification information. For example, it is 10 minutes before the hospital visit schedule. “Are you ready?” may be displayed. The elderly person living alone sees the terminal 5, replies to the notification information, and communicates safety of the watching target person.

If a response to the notification information is not received from the terminal 5 of the watching target person within a predetermined time, the watching server 2 may transmit the notification information indicating that the watching target person is in an abnormal state to the terminal of the watching target person. The fact that no response is received from the terminal 5 of the watching target person indicates that the watching target person may arrive at home. The identification information of the terminal of the watching target person is associated with the identification information of the terminal 5 of the watching target person in the database of the storage unit 23.

### Step S310: Determination Step

In the watching server 2, if the schedule information indicates that the watching target person is out and the log information indicates that the watching target person is not using the home appliance 3, the notification determination unit 223 of the control unit 22 does not generate the notification information notified to the watching target person because the notification information indicates that the watching target person is scheduled to go out and is absent. Thus, the notification transmission unit 224 may not transmit the notification information to the terminal 5.

The notification determination unit 223 may determine the notification information for confirming that there is no problem for the watching target person, and the notification transmission unit 224 may transmit the notification information to the terminal 5.

### Embodiment

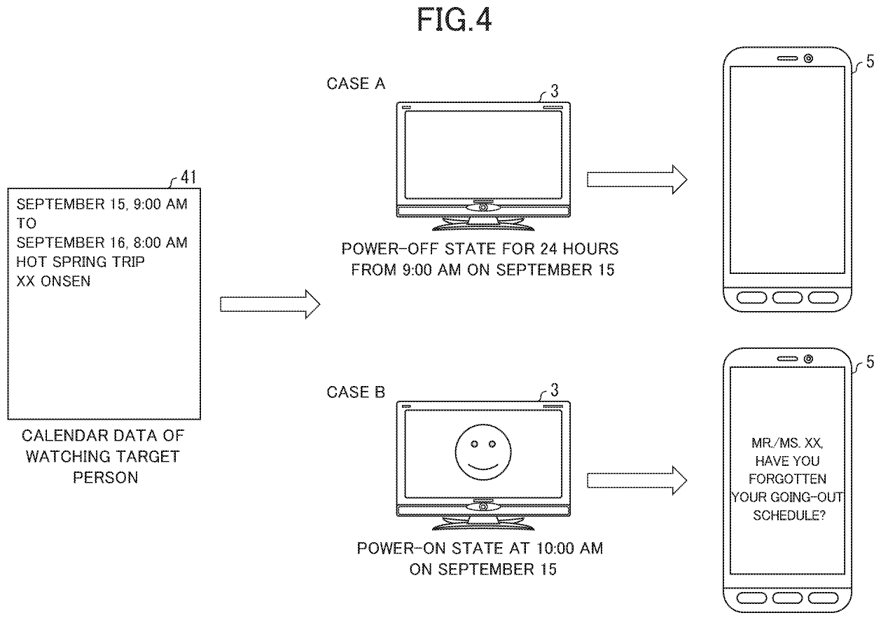

FIG. 4 is a diagram illustrating an example of processing of the at-home determination system 1 according to the present embodiment. The watching server 2 receives the calendar data 41 of the watching target person from the schedule server 4 as the schedule information. The calendar data 41 indicates that the watching target person goes on a hot spring trip from 9:00 am on September 15 to 8:00 pm on September 16.

In a case A, the watching server 2 receives the log information indicating that the home appliance 3 is in a power-off state for 24 hours from 9:00 am on September 15. In this case, even if the home appliance 3 is in the power-off state for 24 hours, the watching server 2 does not generate the notification information to notify the watching target person because the watching target person is scheduled to go out during that time. Thus, the terminal 5 does not display information on the watching target person. Since the home appliance 3 is in the power-off state, even if the watching server 2 does not receive the log information indicating an operation state from the home appliance 3 for a predetermined time or more, when the watching target person is scheduled to go out in the meantime, the notification information to notify the watched people is not generated.

In case B, the watching server 2 receives the log information indicating that the home appliance 3 is turned on at 10:00 am on September 15. In this case, the watching server 2 generates the notification information for confirming the going-out schedule to the watching target person because the home appliance 3 is turned on even though the watching target person is scheduled to go out. In this case, for example, there is a possibility that the watching target person forgets the going-out schedule. Thus, the terminal 5 displays “Mr./Ms. XX, have you forgotten your going-out schedule?”.

As described above, the watching server 2 according to the present embodiment includes the communication unit 21 and the control unit 22, and the control unit 22 acquires, via the communication unit 21, the log information indicating a use status of the home appliance 3 by the watching target person and the schedule information indicating a schedule of the watching target person, and determines the notification information notified to the watching target person with reference to the log information and the schedule information. Accordingly, the watching target person may input his/her own schedule, and the watching target person does not demand to set the going-out to the television and does not demand to set a going-out schedule. Thus, the going-out schedule of the watching target person can be surely grasped, and thereby, it is possible to perform an appropriate going-out confirmation.

Further, in the watching server 2 according to the present embodiment, if the schedule information indicates that the watching target person is out and the log information indicates that the watching target person is not using the home appliance 3, the control unit 22 does not generate the notification information to notify the watching target person. Accordingly, it is possible to avoid a useless notification to the watching target person.

Further, in the watching server 2 according to the present embodiment, if the schedule information indicates that the watching target person is out and the log information indicates that the watching target person is using the home appliance 3, the control unit 22 generates the notification information for confirming a going-out schedule to the watching target person. Accordingly, it is possible to notify the watching target person to confirm the going-out schedule.

The watching target person (target person) may be not only a person who demands to watch, such as an elderly person, but also a healthy person who is not elderly.

### Second Embodiment

A second embodiment according to the present disclosure will be described below. For the sake of convenient description, a member having the same function as the member described in the first embodiment are denoted by the same reference numeral, and description thereof will not be repeated.

The schedule server 4 of the at-home determination system 1 may determine whether or not an event input to a calendar application is a going-out schedule based on the following criteria. The following illustrates an example of criteria, and a plurality of criteria may be combined or may be determined based on other criteria.

(1) A calendar event is regarded as a going-out schedule. That is, the input event is recognized as being accompanied by going-out.
(2) In the calendar event, anything entered in a place item is regarded a going-out schedule. In other words, it is recognized that the home is not input in the place item.
(3) A check box of the going-out schedule is added to the calendar event, and checking is regarded as the going-out schedule.
(4) In the calendar event, anything that includes a place in a title item is regarded as the going-out schedule. For example, a title “travel to XX hot spring” is regarded as the going-out schedule.
(5) If content of the event is content that is estimated to be the going-out, the event is regarded as the going-out schedule. For example, contents of “hospital visit” and “travel” are regarded as the going-out schedule.

### Third Embodiment

A third embodiment according to the present disclosure will be described below. For the sake of convenient description, a member having the same function as the member described in the first embodiment is denoted by the same reference numeral, and description thereof will not be repeated.

The watching server 2 of the at-home determination system 1 may limit a target event which transmits notification information and a notification destination according to the following criteria.

(1) The target event and the notification destination are not limited.
(2) Notification is limited to a specific event. For example, when a watching target person inputs an event to a calendar application, flags such as “notification-demanded” and “principalship” can be set to the event, and the flag is referred to. Further, if a specific keyword (for example, “hospital visit”, “travel” or the like) is included in the event name, it is determined as the “notification-demanded”. Further, it is determined as the notification-demanded for an event having a long time.
(3) Notification is limited to a specific notification destination. For example, when the watching target person inputs an event to the calendar application, a list of notification destinations and a check box are displayed, and the notification destination can be selected. Further, a related person is determined from a name of the event and notified. For example, in a case of “hospital visit”, a hospital staff is set as the notification destination, and in a case of “family trip”, a family is set as the notification destination, and in a case of “district meeting”, the civil welfare committeeman is set as the notification destination.

Although the first to third embodiments are described above in relation to watch, the embodiments of the present disclosure may be applied to other usages. For example, the present disclosure may be applied not only to the watching purpose of an elderly person or the like but also to confirming a going-out schedule for a healthy person who is not aged when the healthy person is scheduled to go out and is at home.

### Fourth Embodiment

In each of the above embodiments, an example in which one watching server 2 is used is described, but each function of the watching server 2 may be realized by as individual server. When a plurality of servers are applied, the respective servers may be managed by the same business person and may be managed by a different business person.

### Fifth Embodiment

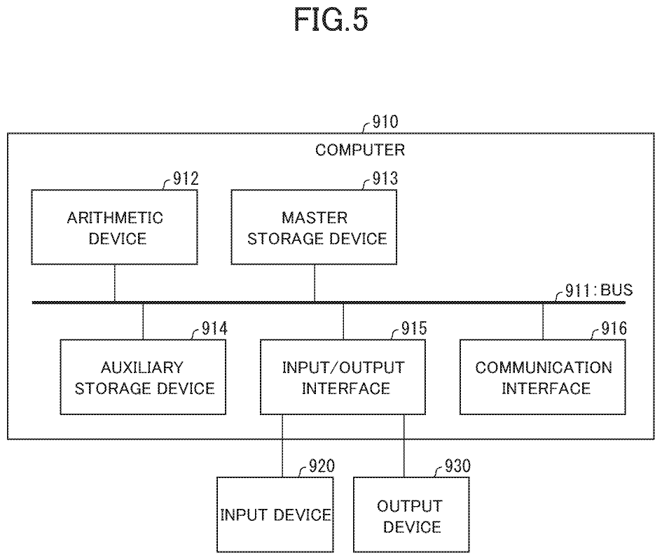

Each block of the watching server 2 may be realized by a logic circuit (hardware) formed in an integrated circuit (IC chip) or the like, or may be realized by software. In the latter case, each of the watching servers 2 can be configured by using a computer (electronic calculator) illustrated in FIG. 5.

FIG. 5 is a block diagram illustrating a configuration of a computer 910 that can be used as the watching server 2. The computer 910 includes an arithmetic device 912, a master storage device 913, an auxiliary storage device 914, an input/output interface 915, and a communication interface 916 that are connected to each other via a bus 911. The arithmetic device 912, the master storage device 913, and the auxiliary storage device 914 may be, for example, a processor (for example, CPU: Central Processing Unit), a random access memory (RAM), and a hard disk drive. The input/output interface 915 is connected to an input device 920 for a user to input various types of information to a computer 910 and an output device 930 for the computer 910 to output various types of information to the user. The input device 920 and the output device 930 may be embedded in the computer 910 or may be connected (externally attached) to the computer 910. For example, the input device 920 may be a keyboard, a mouse, a touch sensor, or the like, and the output device 930 may be a display, a printer, a speaker, or the like. Further, a device having both functions of the input device 920 and the output device 930, such as a touch panel in which a touch sensor and a display are integrated, may be applied. The communication interface 916 is an interface for the computer 910 to communicate with an external device.

The auxiliary storage device 914 stores various programs for operating the computer 910 as the server 2. The arithmetic device 912 develops a program stored in the auxiliary storage device 914 on the master storage device 913 and performs a command included in the program, thereby, causing the computer 910 to function as each unit included in the watching server 2. A recording medium which is included in the auxiliary storage device 914 and records information such as a program may be a computer-readable “non-temporary tangible medium”, and may be, for example, a tape, a disk, a card, a semiconductor memory, a programmable logic circuit, or the like. Further, the master storage device 913 may be omitted if the computer can execute the program recorded in the recording medium without developing it on the master storage device 913. Each of the above devices (the arithmetic device 912, the master storage device 913, the y storage device 914, the input/output interface 915, the communication interface 916, the input device 920, and the output device 930) may be a single or may be plural.

Further, the program may be acquired from the outside of the computer 910, and in this case, the program may be acquired via a certain transmission medium (a communication network, a broadcast wave, or the like). The present disclosure can also be realized in the form of a data signal embedded in a carrier wave in which the program is embodied by an electronic transmission.

The present disclosure is not limited to the above-described respective embodiments, and various modifications are possible within the scope described in the claims, and embodiments obtained by appropriately combining technical means disclosed in different embodiments are also included in the technical scope of the present disclosure. Furthermore, a new technical feature can be formed by combining the technical means disclosed in each embodiment.

The present disclosure contains subject matter related to that disclosed in Japanese Priority Patent Application JP 2018-209856 filed in the Japan Patent Office on Nov. 7, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a communication unit; and
a control unit,
wherein the control unit acquires log information indicating a use status of a home appliance by a target person and schedule information indicating a schedule of the target person, via the communication unit, and
wherein the control unit determines notification information to be notified to the target person with reference to the log information and the schedule information.

2. The information processing apparatus according to claim 1, wherein the control unit does not generate the notification information to be notified to the target person, when the schedule information indicates that the target person is out and the log information indicates that the target person does not use the home appliance.

3. The information processing apparatus according to claim 1, wherein the control unit generates the notification information for confirming a going-out schedule to the target person, when the schedule information indicates that the target person is out and the log information indicates that the target person is using the home appliance.

4. An information processing method using an information processing apparatus comprising:
acquiring log information indicating a use status of a home appliance by a target person and schedule information indicating a schedule of the target person; and
determining notification information to be notified to the target person with reference to the log information and the schedule information.
